(19) United States
(12) Patent Application Publication
(10) Pub. No.: US 2026/0352507 A1
(43) Pub. Date: Nov. 5, 2026

(54) CABLE MODEM REGISTRATION PROCESS

(71) Applicant: Charter Communications Operating, LLC, St. Louis, MO (US)

(72) Inventors: Shlomo Ovadia, Denver, CO (US); Carson Fisher, Greenwood Village, CO (US)

(73) Assignee: Charter Communications Operating, LLC, St. Louis, MO (US)

(21) Appl. No.: 19/198,582

(22) Filed: May 5, 2025

(51) Int. Cl. H04L 12/28

(52) U.S. Cl. CPC H04L 12/2801

(57) ABSTRACT

A provisioning server, a registration/communication server (e.g., a cable modem termination system (CMTS)), and an access device (e.g., a cable modem (CM)) for a communication network communicate to register or re-register the access device in the communication network, using a configuration file for the access device, to enable the access device to become operational in the communication network without the access device ever receiving the configuration file. In response to access device ranging, the registration/communication server requests and receives the configuration file from the provisioning server. When the access device requests registration in the communication network, the registration/communication server processes information in the configuration file to determine whether to grant the request. By not sending the configuration file to the access device, the new access device registration process reduces the risk of the access device being a compromise point at the customer site (e.g., by preventing the access device from loading a compromised Config file).

### BACKGROUND

### Field of the Disclosure

The present disclosure relates to cable modem-based communication networks and, more specifically but not exclusively, to processes for registering cable modems in such communication networks.

### Description of the Related Art

This section introduces aspects that may help facilitate a better understanding of the disclosure. Accordingly, the statements of this section are to be read in this light and are not to be understood as admissions about what is prior art or what is not prior art.

FIG. 1 is a signal sequence diagram representing a conventional process 100 for registering a cable modem (CM) 120 into a communication network. Process 100 begins in step 101 with the cable modem 120 transmitting a TFTP Read Request (TFTP-RRQ) message to a dedicated TFTP provisioning server 130 of the backend system of the communication network using the Trivial File Transfer Protocol (TFTP) standardized in Network Working Group (NWG) Request for Comments (RFC) 1350, the teachings of which are incorporated herein by reference. In response, in step 102, the provisioning server 130 transmits a file of TFTP configuration information (i.e., the CM Config file) to the cable modem 120.

In step 103, the cable modem 120 transmits a registration request to a cable modem termination system (CMTS) 140 of the backend system of the communication network. If the CMTS 140 determines that the registration request is approved, then, in step 104, the CMTS 140 transmits a positive registration response to the cable modem 120, which, in step 105, transmits a registration acknowledgement (ACK) to the CMTS 140. At that point, the cable modem 120 is registered into the communication network and is available to become operational that network.

### SUMMARY

The conventional process 100 of FIG. 1 for registering a cable modem has a number of disadvantages, including one or more of the following:
There are a limited number (e.g., 1024) of simultaneous connections that a TFTP provisioning server 130 can support;
Authentication—the TFTP protocol does not have built-in authentication, which makes it less secure than other protocols like the File Transfer Protocol (FTP). This means that anyone can access files without providing credentials;
Directory Visibility—the TFTP protocol does not provide visibility into the files and directories available on the TFTP provisioning server 130;
Transport Protocol—the TFTP protocol is not robust since it uses the User Datagram Protocol (UDP) and does not have built-in error checking. Blocks get ACK'd by the TFTP provisioning server 130 itself, though. So, a missed block can be detected, but a corrupted block might not, etc.

Problems in the prior art are addressed in accordance with the principles of the present disclosure by new techniques for registering cable modems that avoid some or all of the disadvantages of the conventional technique.

In the conventional modem registration process 100 of FIG. 1, after initial ranging, Dynamic Host Configuration Protocol (DHCP), and Time of Day (ToD) processes, the cable modem 120 sends a request to the TFTP provisioning server 130 to receive the cable modem's configuration file (AKA Config file). Then, the cable modem 120 processes the Config file and sends a registration request to the CMTS based on its capabilities.

In certain implementations of the present disclosure, the cable modem never receives the Config file. Instead, the CMTS sends an HTTPS request to the provisioning server using the CM MAC address that the CMTS learned during the cable modem's initial ranging process. The CMTS downloads and processes the CM Config file. After the cable modem obtains its IP address (i.e., the DHCP process is successfully completed), the cable modem sends a new registration request to the CMTS, declaring only its capabilities. The CMTS sends a new registration response message to the cable modem, confirming its capabilities, adds provisioned info/Service Flows and all relevant info from the Config file.

This new process eliminates the cable modem as a potential compromise point at the customer site (e.g., home). In addition, the exchange of dynamic shared secrets between the CMTS and the cable modem can be removed. Furthermore, this new process potentially enables Dynamic CM Config updates without rebooting the cable modem since the cable modem is already online.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a signal sequence diagram representing a conventional process for registering a cable modem into a communication network;

FIG. 2 is a signal sequence diagram representing a process for registering a cable modem into a communication network, according to certain embodiments of the present disclosure;

FIG. 2A is a signal sequence diagram representing a process for registering a cable modem into a communication network, according to certain other embodiments of the present disclosure;

FIG. 3 is a signal sequence diagram providing details of the HTTPS CMTS sequence for steps B02 and B03 of FIG. 2;

FIG. 4A is a table tabulating the estimated time that it takes to perform the conventional modem registration process of FIG. 1, and FIG. 4B is a table tabulating the estimated time that it takes to perform the new modem registration process of FIG. 2;

FIG. 5 is a diagram that shows how Message Integrity Checks (MICs) may be generated and used by the provisioning server, the cable modem, and/or the CMTS of FIG. 2;

FIG. 6 is a simplified hardware block diagram of an example node that can be used to implement any of the cable modem, provisioning server, CMTS, and DHCP server of FIGS. 2, 2A, and 7; and

FIG. 7 is a signal sequence diagram representing a process for re-registering the cable modem 220 in order to update the configuration of a cable modem after the cable modem has been registered into a communication network, according to certain other embodiments of the present disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

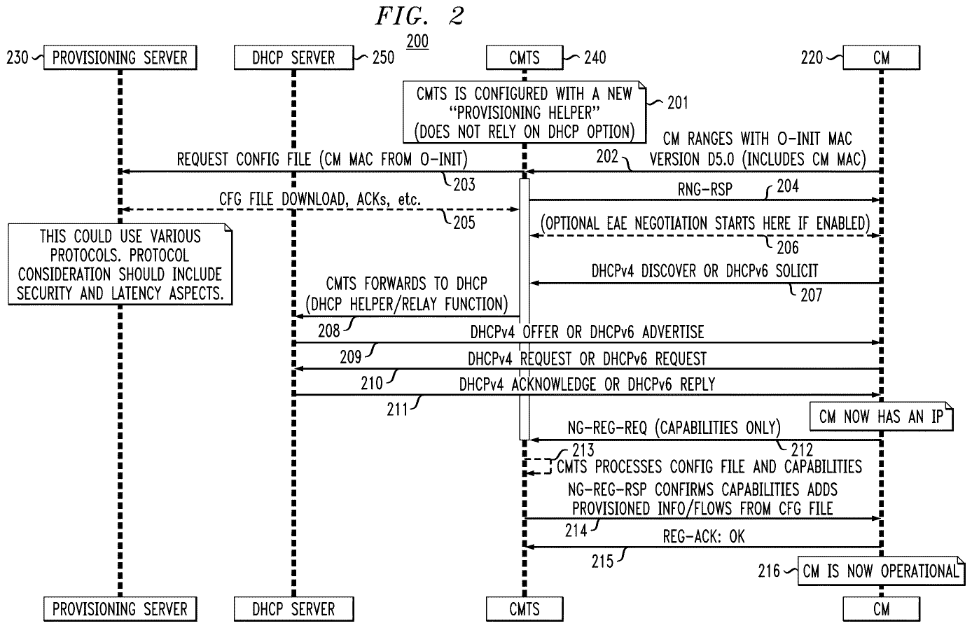

FIG. 2 is a signal sequence diagram representing a new process 200 for registering a cable modem (CM) 220 into a communication network, according to certain embodiments of the present disclosure. The diagram shows a RNG-RSP (Ranging Response) with a single sequence here, which can be a conversation that varies depending on how much RF adjustment the cable modem 220 needs to perform. The sequence can vary based on the cable modem's RF plant/power conditions, etc. That sequence is not changed by the process 200.

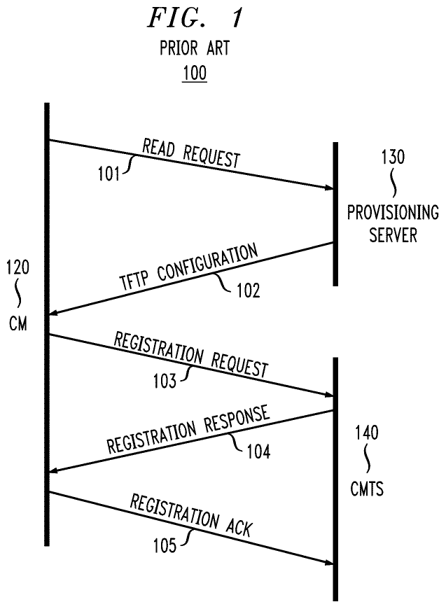

In step 201, a CMTS 240 of a backend system of the communication network is configured with the new provisioning helper software (i.e., IP) for the provisioning server (PS) 230. The “Provisioning Helper IP” is a new configuration parameter that the CMTS 240 needs for the process 200. In the conventional process 100 of FIG. 1, a CMTS gleans what IP to use for a TFTP Proxy/file download via options on the Dynamic Host Configuration Protocol (DHCP) packets exchanged on a per-CM basis (CMTS snoops these packets). In the process 200 of FIG. 2, the CMTS 240 requests the cable modem's Config file before the cable modem 220 has entered DHCP, so there is nothing to snoop at that point in time. The pre-configured Provisioning Helper IP configuration parameter tells the CMTS 240 what IP to contact to start the file download over HTTPS or any other secure protocol.

In step 202, the cable modem 220 initiates a ranging process using a RNG-REQ message transmitted to the CMTS 240. In particular, the cable modem 220 sends an OFDMA Initial Ranging Request (O-INIT-RNG-REQ) message only in maintenance regions or non-extended upstream channels. The O-INIT-RNG-REQ message includes the cable modem's 64-bit Media Access Control (MAC) address. In response, in some implementations, the CMTS 240 sends TLV23 in a MAC Domain Descriptor (MDD) message to the cable modem 220 for each version of BPI+ that is enabled, and the cable modem 220 checks the MDD message if Early Authentication and Encryption (EAE) is disabled for the negotiated version of BPI+. EAE is an optional process that the cable modem 220 could enter, per the Operator's configuration of the CMTS 240. It is not a new item for this method, nor is it required or forbidden by the process 200. After the CMTS 240 receives the O-INIT-RNG-REQ, the CMTS 240 and the cable modem 220 conduct a conventional ranging process, per existing Data Over Cable Service Interface Specifications (DOCSIS) wording. The next “new step” for this method is when the CMTS 240 requests the Config file from the provisioning server 230 in step 203, directly after O-INIT-RNG-REQ is received. Ranging continues directly after O-INIT, asynchronously from the Config Request to the provisioning server 230. The ranging continues, independent of how long it takes the CMTS 240 to get the Config file from the provisioning server 230; the CMTS 240 does not hold for the file download to complete. In other words, the Config file download and ranging processes within the CMTS 240 are asynchronous from each other. The CMTS 240 has until step 212 to get the Config file, so that the Config file is present on the CMTS 240 by the time the NG-REG-REQ arrives in step 212.

The O-INIT-RNG-REQ message is a conventional initial ranging request message sent by the cable modem 220 to the CMTS 240 only in Initial Maintenance Regions and only on non-extended Orthogonal Frequency-Division Multiple Access (OFDMA) upstream channels (hence the O—). There are several different ranging request messages the cable modem 220 could send. In the process 200, the cable modem 220 uses OFDMA in order to send the O-INIT version, which is the only version of an initial ranging request that contains the cable modem MAC address and allows the process 200 to work. OFDMA channels are expected since they have existed since D3.1 modems and will carry forward into D4.0 modems and beyond. The O-INIT-RNG-REG message is transmitted by the cable modem 220 using the following format:

| | | |
|---|---|---|
| MAC Address | DS-CHAN-ID | CRC-24 |
| (6 bytes) | (1 byte) | (3 bytes) |

where:
MAC Address: The MAC address of the cable modem 220;
DS-CHAN-ID: The identifier of the downstream channel on which the cable modem 220 is receiving the Upstream Channel Descriptors (UCDs) and Mappings of Addresses and Ports (MAPs) which describe this upstream channel; and
CRC-24: 24-bit Cyclic Redundancy Check (CRC) hash over the MAC address and the DS-CHAN-ID.

Baseline Privacy Interface Plus (BPI+) is a conventional, optional security/encryption scheme used in DOCSIS. BPI+ provides a level of data privacy across the shared-medium communication network equal to or better than that provided by dedicated-line network access services. D4.0 modems and beyond will use BPI+ Version 2. It is shown here since it is typically something the Operator does turn on.

A MAC Domain Descriptor (MDD) message is a conventional message that is periodically sent by a D3.0 or higher CMTS on downstream channels. An MDD message describes various configuration items that are read by all D3.0 and higher cable modems. An MDD message signals what downstream and upstream channels are available for use, if EAE is supported, and many other items.

The CMTS 240 transmits a separate MDD message periodically on every downstream channel in the MAC Domain. The CMTS 240 does not transmit an MDD message with a total Management Message Payload size of more than 8000 bytes. The MDD message is intended primarily for use by the cable modem 220 during initialization. The MDD message also includes parameters related to CM-STATUS reporting which may be useful after registration. After registration, the cable modem 220 uses the TLVs applicable to CM-STATUS reporting to control its CM-STATUS reporting. The cable modem 220 does not modify anything other than its CM-STATUS reporting behavior in response to changes in the MDD message in the absence of other stimuli. For example, the cable modem 220 does not delete a channel from its Receive Channel Set if that channel is no longer listed in the MDD message. However, during registration or while processing a dynamic bonding change containing a Simplified RCC Encoding, the cable modem 220 uses the Downstream Active Channel List TLVs from the most-recent MDD message to acquire downstream channels.

If Type-Length-Value (TLV) 23 is not present in the MDD message, then the cable modem 220 assumes that the CMTS 240 supports only BPI+V1. The CMTS BPI+-enabled version and configuration TLV and sub-TLV are shown in the table below. The CMTS 240 is expected to transmit the same value of MDD message TLV 23 on all primary-capable channels of a downstream service group on a MAC domain.

| Type | Length | Value |
|---|---|---|
| 23 | N | BPI Plus Enabled Version and Configuration |
| 23.1 | 1 | BPI Plus Version Number. |
| | | This byte carries the version number of BPI+ |
| | | that is enabled on the CMTS |
| | | 1: Indicates that BPI+ Version 1 is enabled |
| | | 2: Indicates that BPI+ Version 2 is enabled |
| | | 3-255: Reserved |
| 23.2 | 1 | BPI Plus Configuration Bitmask: 1 byte. |
| | | Each bit in this field represents the enable/disable |
| | | for a particular feature connected to the version of |
| | | BPI+ that is enabled. If a bit is 1, the corresponding |
| | | feature is enabled. If a bit is zero, the |
| | | corresponding feature is disabled. The following |
| | | bit fields are defined: |
| | | Bit 7: (EAE-Configuration) Indicates that EAE is enabled |
| | | for the BPI+ version indicated in the BPI Plus |
| | | Version Number |
| | | Bits 0-6: Reserved |

The initial ranging process in a D3.1 modem involves the modem sending Range Requests to the CMTS 240 increasing power levels until a Range Response is received. This process occurs during a “contention” window where the CMTS 240 does not have prior knowledge of the modem, potentially leading to collisions if multiple modems attempt to register simultaneously. The DOCSIS standard includes a back-off mechanism to mitigate these collisions.

MDD TLV 23 (which is really 23.1 and 23.2) is included for D4.0 and up, to clarify which BPI+ versions are supported by the CMTS. In general, embodiments of the present disclosure can be implemented with or without BPI+, MDD TLV 23.1/23.2, and/or EAE.

In step 203, the CMTS 240 sends a request configuration (REQ Config) file message to the provisioning server 230 using the CM MAC (secure protocol). In particular, the CMTS 240 uses Hypertext Transfer Protocol Secure (HTTPS) Get and Response messages for communications with the provisioning server 230, where both messages are encrypted using Secure Sockets Layer (SSL) or Transport Layer Security (TLS) encryption. Other secure transmission protocols can be used.

In step 204, asynchronously to step 203, the CMTS 240 transmits a ranging response (RNG-RSP) message to the cable modem 220.

In step 205, the provisioning server 230 begins the process of downloading the CM Config file for the cable modem 220 to the CMTS 240, which the CMTS 240 acknowledges with an ACK message to the provisioning server 230. The protocol used by the CMTS 240 to download the CM Config file could vary depending on the implementation. In preferred implementations, a modern protocol that is better and more secure than TFTP is used. HTTP is an example. Other possibilities include some new type of API that is developed as a standardized interface. One needs to strike a balance between security and latency when choosing the protocol to establish and deliver the Config file.

In step 206, if EAE is enabled, the cable modem 220 starts EAE negotiation by sending an initiate authentication event to the BPI+ Auth State Machine immediately following the completion of ranging. If EAE is not enabled, then the process 200 skips step 206 and proceeds to step 207.

In step 207, depending on the capability/version of the cable modem 220 and the configuration of the CMTS 240 that has been applied by the Operator, the cable modem 220 sends either a conventional Dynamic Host Configuration Protocol Version 4 (DHCPv4) Discover message, a conventional DHCPv6 Solicit message, or both to the CMTS 240.

In step 208, the CMTS 240 forwards the DHCPv4 Discover and/or DHCPv6 Solicit messages to a DHCP server (Helper/Relay function) 250 of the backend system of the communication network. The DHCPv4 Discover/DHCPv6 Solicit messages are conventional DHCP protocol messages. The modem preference is to send a DHCPv6 Solicit message to obtain an IPv6 address. If a DHCPv6 server is not available, then the modem 220 can try to send a DHCPv4 Discover message.

In steps 209-211, the DHCP server 250 and the cable modem 220 communicate to complete the DHCP process according to conventional procedures. In particular, in step 209, the DHCP server 250 offers DHCPv4 and/or advertises DHCPv6 to the cable modem 220. In step 210, the cable modem 220 responds by requesting either DHCPv4 or DHCPv6 or both from the DHCP server 250. In step 211, the DHCP server 250 transmits either a DHCPv4 ACK or a DHCPv6 Reply or both to the cable modem 220. At the completion of the DHCP process, depending on the implementation, the cable modem 220 will have an IPv4 address and/or an IPv6 address.

In step 212, the cable modem 220 sends an NG-REG-REQ message to the CMTS 240, declaring its capabilities. Next Generation Registration Request (NR-REG-REQ) is a hypothetical name for a new DOCSIS MAC Management message that the cable modem 220 will send to the CMTS 240 for the process 200. To keep backward compatibility with the conventional modem registration process 100 of FIG. 1, the new NR-REG-REQ message is used only by the process 200. The exact name for this message depends on what a future DOCSIS standard sets for the name. This message contains the capabilities of the cable modem 220. The CMTS 240 will process that information to determine what goes into the registration response it sends.

In step 213, the CMTS 240 ingests and processes the CM Config file received in step 205 and the CM capabilities received in step 212. The CMTS 240 (i) parses and processes the CM Config file received from the provisioning server 230 and (ii) examines the CM capabilities received in the NG-REQ-REQ message from the cable modem 220 in order to prepare a modem registration response message NG-REG-RSP, which includes all of the relevant configuration that pertains to the cable modem 220, considering the capabilities the cable modem 220 has indicated it can support. Next Generation Registration Response (NG-REG-RSP) is a hypothetical name for a new DOCSIS MAC Management message that the CMTS 240 will send to the cable modem 220 for the process 200. To keep backward compatibility with the conventional modem registration process 100 of FIG. 1, the new NG-REG-RSP message is used only by the process 200. The exact name for this message depends on what a future DOCSIS standard sets for the name.

In step 214, the CMTS 240 sends the NG-REG-RSP message to the cable modem 220, confirming its capabilities, adding the provisioned service flows' QoS parameters, and all the relevant information from the CM Config file that is needed by the cable modem 220 to be fully operational. The Provisioned Service Flows are conventional items that the cable modem 220 receives. If the cable modem 220 does not receive the NG-REG-RSP message before an internal CM timer expires, then the cable modem 220 causes steps 212-214 to repeat by re-sending the NG-REG-REQ message and starting a new CM timer.

In step 215, the cable modem 220 transmits an ACK to the CMTS 240, acknowledging the CMTS response message of step 214. At this point (step 216), the cable modem 220 is now fully registered and operational in the communication network.

Note that, in the new cable registration process 200 of FIG. 2, steps 203, 205, and 212-214 are not part of the conventional cable registration process 100 of FIG. 1.

Although the steps in the new cable registration process 200 of FIG. 2 are presented in a particular order, those skilled in the art will understand that, in alternative implementations, those steps may appear in other, practical sequences.

FIG. 2A is a signal sequence diagram representing a new process 200A for registering the cable modem 220 into a communication network, according to certain other embodiments of the present disclosure. In FIG. 2A:
Steps 201A-206A are similar to steps 201-206 of FIG. 2;
Step 207A and 208A are similar to steps 212 and 213 of FIG. 2;
Steps 209A-213A are similar to steps 207-211 of FIG. 2; and
Steps 214A-216A are similar to steps 214-216 of FIG. 2.
   The difference between the cable modem registration process 200 of FIG. 2 and the cable modem registration process 200A of FIG. 2A is that, in FIG. 2, the transmission of the NG-REG-REQ message (step 212 of FIG. 2) and the processing of the Config file and capabilities (step 213 of FIG. 2) occur after the DHCP processing (steps 207-211 in FIG. 2), while, in FIG. 2A, the similar steps (steps 206A and 208A in FIG. 2A) occur before the DHCP processing (steps 209A-213A in FIG. 2A). Those skilled in the art will understand that the Config file and capabilities processing of step 206A of FIG. 2A may begin anywhere between step 205A and step 214A, but it needs to receive the cable modem capabilities in step 208A to complete the processing of step 206A.

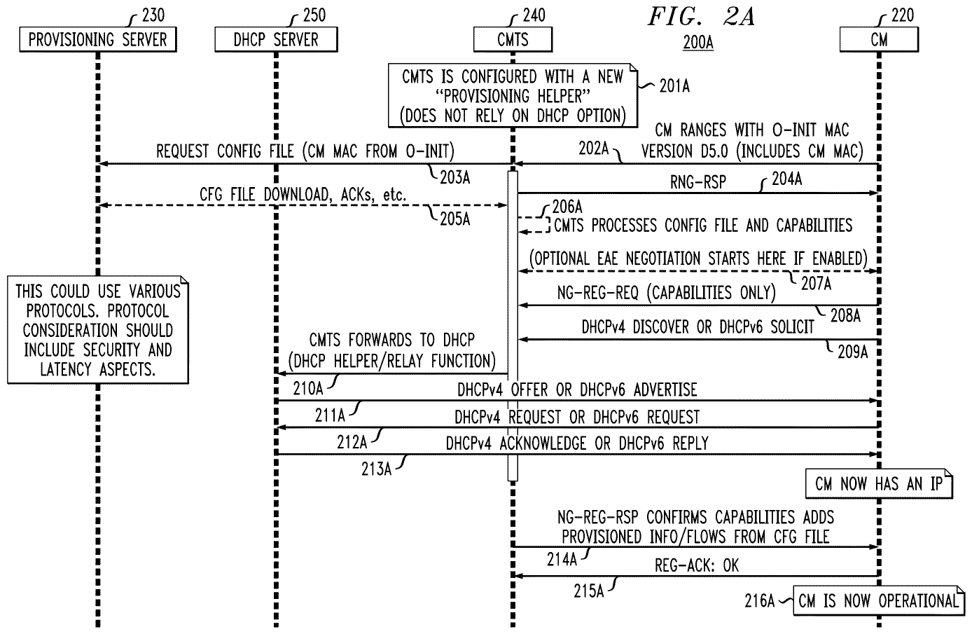

FIG. 3 is a signal sequence diagram providing details of the HTTPS CMTS sequence for steps 203 and 205 of FIG. 2.

In step 301, the CMTS 240 (i.e., the client) initiates the connection by sending a “ClientHello” message, which includes information like SSL/TLS versions, cipher suite, and random data.

In step 302, the provisioning server 230 responds with a “serverHello” message, specifying the SSL/TLS version, cipher suite, and random data it has chosen for the session.

In step 303, the provisioning server 230 sends its digital certificate to the CMTS 240 to authenticate itself.

In step 304, if required, the provisioning server 230 sends additional key exchange parameters to the CMTS 240.

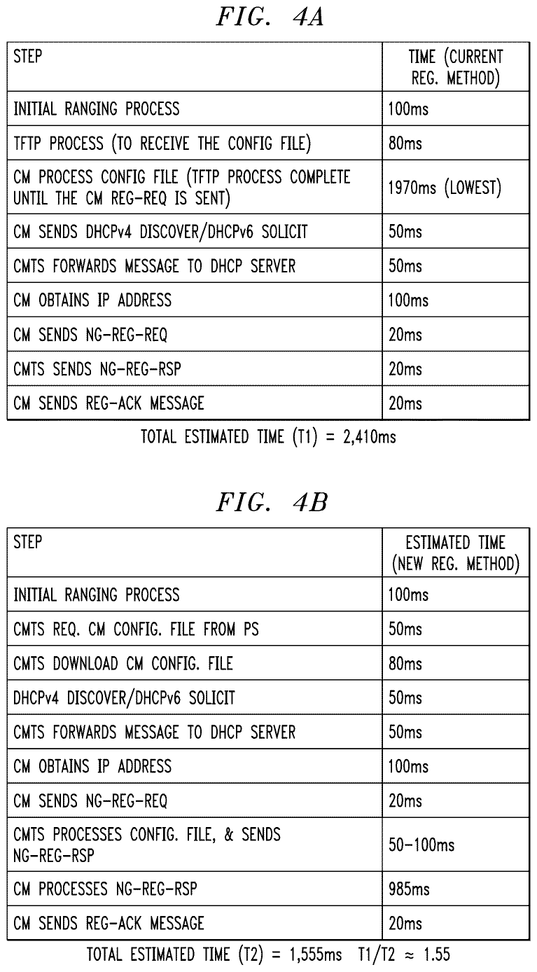

In step 305, the CMTS 240 generates a premaster secret value (PreMasterSecret) and encrypts it with the provisioning server's public key, then sends the encrypted premaster secret value (EncryptedPreMasterSecret) to the provisioning server 230. The premaster secret value is used by the CMTS 240 and the provisioning server 230 to derive the shared master secret value, which is used to generate Message Integrity Checks (MICs), as described below in the context of FIG. 5.

In step 306, the CMTS 240 sends a “ChangeCipherSpec” message to the provisioning server 230, indicating that subsequent messages will be encrypted.

In step 307, the CMTS 240 sends a “Finished” message to the provisioning server 230, which is the first encrypted message using the newly negotiated keys.

In step 308, the provisioning server 230 sends its own “ChangeCipherSpec” message to the CMTS 240.

In step 309, the provisioning server 230 sends its own “Finished” message, encrypted negotiated, to the CMTS 240.

In step 310, the CMTS 240 sends an HTTP request over the encrypted connection to the provisioning server 230.

In step 311, the provisioning server 230 sends an HTTP response over the encrypted connection to the CMTS 240.

The most common cipher suite used in modern HTTPS connections is TLS_ECDHE_RSA_WITH_AES_128_GCM_SHA256. This cipher suite is widely adopted, because it offers a good balance of security and performance. It uses:
ECDHE (Elliptic Curve Diffie-Hellman Ephemeral) for key exchange, which provides forward secrecy;
RSA for authentication;
AES_128_GCM (Advanced Encryption Standard with 128-bit keys in Galois/Counter Mode) for encryption, which is both secure and efficient; and
SHA256 (256-bit Secure Hash Algorithm) for message authentication and integrity.

The time it takes to complete all of the steps in the HTTPS handshake of FIG. 3 can vary greatly based on several factors, including network latency, server performance, client performance, and the complexity of the cryptographic operations involved. Here's a rough estimate:
Minimum Time: In ideal conditions with low network latency and high performance of both client and server, the HTTPS handshake can complete in around 200 milliseconds;
Average Time: Under typical conditions, it usually takes about 500-700 milliseconds to complete the handshake; and
Maximum Time: In scenarios with high network latency or other delays (e.g., server load, network congestion), the time to complete the handshake can extend to several seconds, sometimes up to 2-3 seconds or more.

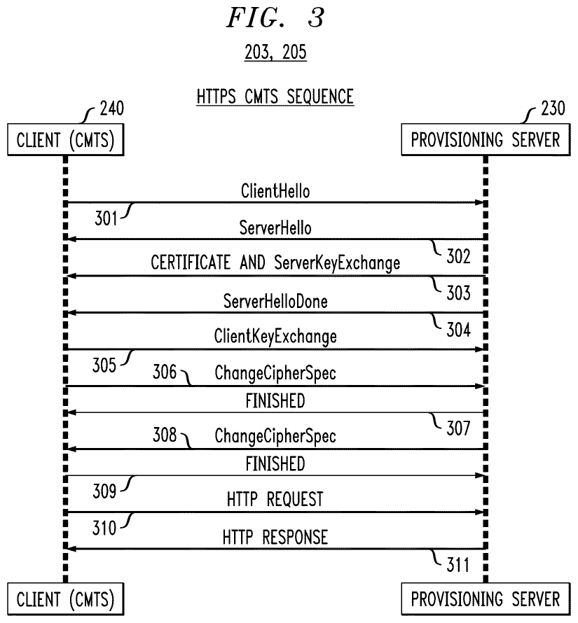

FIG. 4A is a table tabulating the estimated time that it takes to perform the conventional modem registration process 100 of FIG. 1 based on packet captures from D3.1 modems, and FIG. 4B is a table tabulating the estimated time that it takes to perform the new modem registration process 200 of FIG. 2. As indicated by the estimated times (1.555 seconds vs. 2.410 seconds), the new modem registration process 200 of FIG. 2 is faster than the conventional modem registration process 100 of FIG. 1.

FIG. 5 is a diagram that shows how Message Integrity Checks (MICs) may be generated and used by the provisioning server 230, the cable modem 220, and the CMTS 240 of FIG. 2. MICs are used in the conventional modem registration process 100 of FIG. 1 to ensure that the cable modem 120 does not attempt to register with parameters other than the original ones that were sent in the Config file. In the conventional modem registration process, the cable modem 120 receives the full/raw Config file and has an opportunity to possibly modify parameters. In the new modem registration process 200 of FIG. 2, in which the cable modem 220 is never exposed to the full/raw Config file, the CMTS 240 may, but does not need to, employ MICs to modify parameters in the cable modem 220.

In FIG. 5, the left column shows the steps involved in the provisioning server 230 generating a CM Config file, the middle column shows the corresponding phases in that generation at the provisioning server 230, and the right column shows the corresponding phases of the shared secret configuration in which the CMTS 240 uses the shared secret to recalculate the CMTS MIC/TLV 7 as shown in step 506.

In step 501, the provisioning server 230 builds the Config file TLV elements based on DOCSIS specifications and from information provided by various back-office systems (such as billing).

In step 502, the provisioning server 230 hashes the full Config file using a Message Digest 5 (MD5) algorithm to calculate the CM MIC.

In step 503, the provisioning server 230 adds the CM MIC to the CM Config file.

In step 504, the provisioning server 230 calculates the CMTS MIC over selected Config file TLVs (not the entire file) plus the CM MIC using a Shared Secret. The selected Config file TLVs are defined in DOCSIS specifications. Those TLVs are also present in the REG-REQ message sent by the cable modem 220 to the CMTS 240, later in the process (step 212 of FIG. 2).

In step 505, the provisioning server 230 adds the CMTS MIC to the CM Config file. The result of this operation is placed into the CMTS MIC (TLV 7). The CM Config file is now complete and available for download. As shown as step 506 in FIG. 5, when the cable modem 220 registers with the CMTS 240 in step 212 of FIG. 2, the CMTS 240 uses the configured Shared Secret in step 213 to verify that the cable modem 220 is registering with an unaltered Config file.

The shared secret configuration column on the right side of FIG. 5 is an example of a secret, and where/what uses that secret. The shared secret itself is a string set by the operator and used as a seed in the CMTS MIC calculation by both the provisioning server 230 and the CMTS 240. The shared secret is not a calculated value.

The CMTS MIC is the calculated value, essentially using the shared secret as a seed. The actual calculation of the CMTS MIC, meaning what configuration file values to include in it and the supported methods/algorithms with which to calculate it, are called out clearly in various DOCSIS specifications. The new cable modem registration process 200 of FIG. 2 makes no changes to those calculations or algorithms, but it does take away the need for the CMTS 240 to perform those calculations since the cable modem 220 never has the opportunity to manipulate the Config file.

The cable modem registration process of FIGS. 2 and 3 provides one or more of the following advantages:
Eliminates the cable modem 220 as a potential compromise point at the customer home. By having the CMTS 240 ask for the Config file directly, the potential risk for the cable modem 220 to load a compromised Config file is reduced;
Reduces modem registration time (about 1.55× improvement);
Uses a secured server with HTTPS instead of the TFTP provisioning server 130 of FIG. 1 to obtain the CM Config file;
Eliminates the TFTP provisioning server 130 of FIG. 1 from the cable modem registration process;
Removes the exchange of dynamic shared secrets between the CMTS 240 and the cable modem 220;
Includes a CMTS Message Integrity Check (MIC) calculation (MD5 digest) in the cable modem's Registration request—CMTS 240 parses the CM Config file instead;
Avoids the CMTS 240 caching the CM Config file after registration; and
Avoids the cable modem 220 performing the CM-MIC calculation.

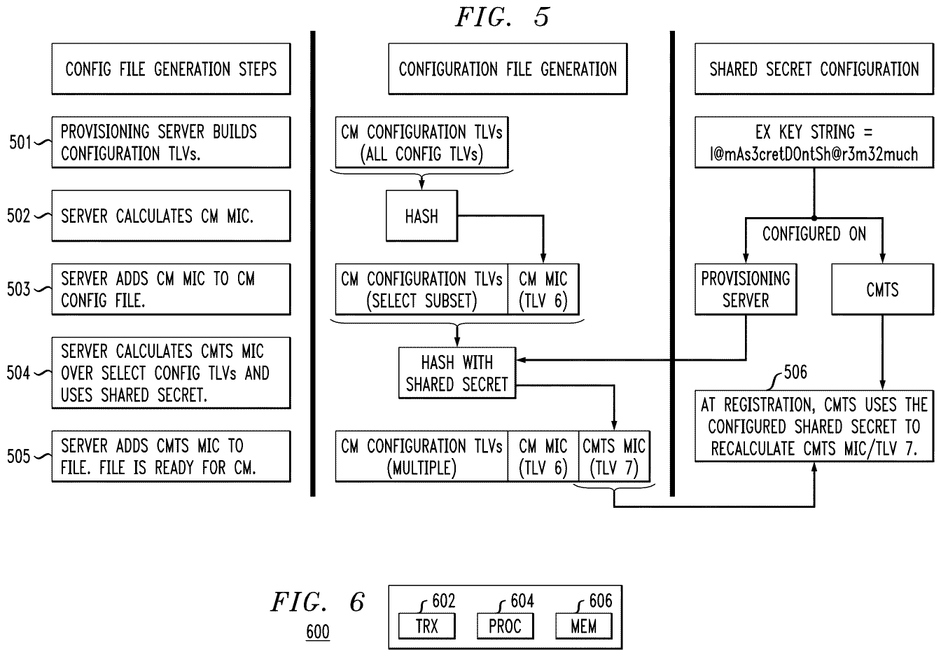

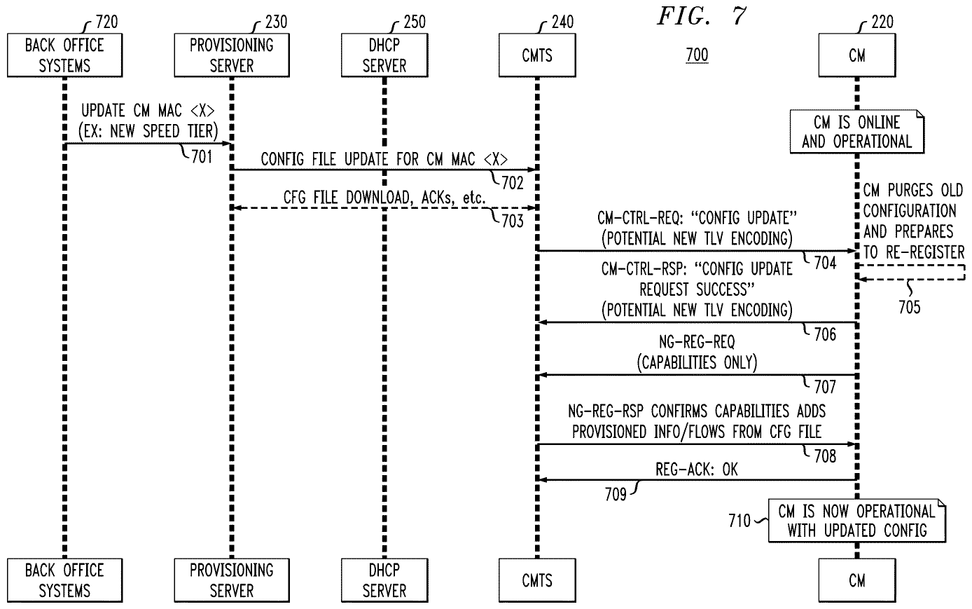

FIG. 6 is a simplified hardware block diagram of an example node 600 that can be used to implement any of the cable modem 220, provisioning server 230, CMTS 240, and DHCP server 250 of FIGS. 2, 2A, and 7. As shown in FIG. 6, the node 600 includes (i) communication hardware (e.g., wireless, wireline, and/or optical transceivers (TRX)) 602 that supports communications with other nodes, (ii) one or more processors (e.g., CPU and/or GPU microprocessors) 604 that control the operations of the node 600 and/or process data within the node 600, and (iii) one or more memories (e.g., RAM, ROM) 606 that store code executed by the processors 604 and/or data generated and/or received by the node 600.

FIG. 7 is a signal sequence diagram representing a new process 700 for re-registering the cable modem 220 in order to update the configuration of the cable modem 220 after the cable modem 220 has been registered into a communication network, e.g., using the process 200 of FIG. 2 or the process 200A of FIG. 2A, according to certain other embodiments of the present disclosure. In the particular example shown in FIG. 7, the cable modem 220 is to be configured with a new speed tier in a configuration push scenario, where an updated configuration is pushed to the cable modem 220 without rebooting the cable modem 220. The configuration updating process 700 most likely has a shorter service disruption window compared to conventional configuration updating processes that involve a full CM reboot.

In this particular scenario, the back-office systems 720 of the communications system are updated such that the CM Config file needs to be updated based on a speed upgrade (i.e., a new speed tier). At the start of the configuration update process 700, the cable modem 220 is online and operational based on the Config file previously transmitted from the provisioning server 230 to the CMTS 240 as in, for example, either step 205 of FIG. 2 or step 205A of FIG. 2A.

In step 701, the back-office billing and service activation systems 720 pass the information regarding the configuration update, in this example, for the new speed tier, to the provisioning server 230, where the cable modem 220 is identified by its MAC address, where “<X>” represents the cable modem's MAC address, such as, for example, <55:07:7D:E5:2F:37>. Those skilled in the art will understand that other configuration updates are possible, such as, without limitation, CM security changes, traffic filtering changes as desired by the operator, or changes to lines of business (e.g., adding or dropping voice service or security filtering), with different information being transmitted from the back-office systems 720 to the provisioning server 230.

In step 702, the provisioning server 230 pushes a Config file update notification to the CMTS 240 informing the CMTS 240 that the cable modem 220 is to have a configuration update. This could be API-based communication.

In step 703, the CMTS 240 sends a request to the provisioning server 230 for the updated Config file embodying the configuration update and the CMTS 240 downloads the updated Config file. This step is similar to the Config file downloads of step 205 of FIG. 2 and step 205A of FIG. 2A.

Once the CMTS 240 has the downloaded and processed the updated Config file as part of step 703, in step 704, the CMTS 240 informs the cable modem 220 that there is to be an updated configuration at the cable modem 220. Step 704 may be accomplished using a conventional CM-CTRL-REQ message but with a new TLV encoding that signifies “Config Update”.

In step 705, the cable modem 220 purges its old configuration from its memory, destroys its existing service flow buffers, etc., and prepares to re-register with an upgraded configuration corresponding to the upgraded Config file stored at the CMTS 240 with new service flows.

After the cable modem 220 has successfully “cleaned itself” in step 705, in step 706, the cable modem 220 sends a conventional CM-CTRL-RSP message (but with a new, configuration-update TLV encoding) confirming that the cable modem 220 is ready, and proceeds with the configuration update. The cable modem 220 could also respond with a code saying that the cable modem 220 is either not ready with the configuration update or request to delay the configuration update to a later time. The CMTS 240 would need to understand both cases.

In step 707, the cable modem 220 sends an NG-REG-REQ message to the CMTS 240 indicating the capabilities of the cable mode 220. This step is similar to step 212 of FIG. 2 and step 208A of FIG. 2A. The CMTS 240 process these capabilities, along with the updated Config file from step 703, and determines what the CMTS 240 needs to send back to the cable modem 220, similar to the processing of step 213 of FIG. 2 and step 206A of FIG. 2A.

Assuming that the CMTS 240 receives a positive CM-CTRL-RSP message in step 706, in step 708, the CMTS 240 sends an NG-REG-RSP message to the cable modem 220, confirming its capabilities, adding the newly provisioned service flows' QoS parameters, and all the relevant information from the updated Config file that is needed by the cable modem 220 to resume full operations at the upgraded speed level. This step is similar to step 214 of FIG. 2 and step 214A of FIG. 2A.

In step 709, the cable modem 220 transmits an ACK to the CMTS 240, acknowledging the CMTS response message of step 708. At this point (step 710), the cable modem 220 is once again fully registered and operational in the communication network but now with the updated configuration. This step is similar to step 216 of FIG. 2 and step 216A of FIG. 2A.

In this configuration push process 700 of FIG. 7, the cable modem 220 foregoes a full re-initialization. In particular, the cable modem 220 does not have to start the ranging process, re-scan the downstream radio frequencies, enter DHCP, etc.

Although the disclosure has been described in the context of communication networks having cable modems and CMTSs, those skilled in the art will understand that the disclosure can be implemented in the context of communication networks having suitable access devices other than cable modems such as, for example, . . . , and suitable registration/communication servers other than CMTSs, such as, for example, . . . . [Shlomo and Carson, if possible, please identify examples of other suitable access devices and other suitable registration/communication servers.]

In certain embodiments of the present disclosure, a system comprises a provisioning server, a registration/communication server, and an access device for a communication network. The registration/communication server is configured to communicate with the provisioning server and the access device to register or re-register the access device in the communication network, using a configuration file for the access device, to enable the access device to become operational in the communication network without the access device ever receiving the configuration file.

In at least some of the above embodiments, the registration/communication server is a cable modem termination system (CMTS); the access device is a cable modem; the cable modem is configured to perform ranging with the CMTS; in response to the ranging, the CMTS is configured to learn the cable modem's address and transmit, to the provisioning server, a Config file request for the configuration file; in response to the Config file request, the provisioning server is configured to transmit the configuration file to the CMTS; the cable modem is configured to transmit a registration request declaring only its capabilities to the CMTS; in response to the registration request, the CMTS is configured to process information in the configuration file to determine whether to grant the registration request; and, upon the CMTS determining to grant the registration request, the CMTS is configured to transmit a registration response to the cable modem to enable the cable modem to become operational in the communication network.

In at least some of the above embodiments, the registration/communication server is configured to communicate with the provisioning server using a secure communication protocol.

In at least some of the above embodiments, the secure communication protocol is a Hypertext Transfer Protocol Secure (HTTPS) protocol.

In at least some of the above embodiments, the registration/communication server is configured to process the information in the configuration file along with declared capabilities of the access device to determine whether to grant a registration request from the access device.

In at least some of the above embodiments, enabling the access device to become operational in the communication network comprises provisioning one or more service flows for the access device and all relevant parameters required for the communications in the communication network.

In at least some of the above embodiments, buffers and memory allocations of the access device are configured to support the one or more provisioned service flows.

In at least some of the above embodiments, the configuration file contains a Message Integrity Check (MIC) generated using a shared secret value.

In at least some of the above embodiments, after previously registering the access device based on the configuration file, the registration/communication server is configured to re-register the access device based on an update to the configuration file without having to fully reboot the access device.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A system comprising a provisioning server, a registration/communication server, and an access device for a communication network, wherein the registration/communication server is configured to communicate with the provisioning server and the access device to register or re-register the access device in the communication network, using a configuration file for the access device, to enable the access device to become operational in the communication network without the access device ever receiving the configuration file.

2. The communication system of claim 1, wherein:
the registration/communication server is a cable modem termination system (CMTS);
the access device is a cable modem;
the cable modem is configured to perform ranging with the CMTS;
in response to the ranging, the CMTS is configured to learn the cable modem's address and transmit, to the provisioning server, a Config file request for the configuration file;
in response to the Config file request, the provisioning server is configured to transmit the configuration file to the CMTS;
the cable modem is configured to transmit a registration request to the CMTS;
in response to the registration request, the CMTS is configured to process information in the configuration file to determine whether to grant the registration request; and
upon the CMTS determining to grant the registration request, the CMTS is configured to transmit a registration response to the cable modem to enable the cable modem to become operational in the communication network.

3. The communication system of claim 1, wherein the registration/communication server is configured to communicate with the provisioning server using a secure communication protocol.

4. The communication system of claim 3, wherein the secure communication protocol is a Hypertext Transfer Protocol Secure (HTTPS) protocol.

5. The communication system of claim 1, wherein the registration/communication server is configured to process the information in the configuration file along with declared capabilities of the access device to determine whether to grant a registration request from the access device.

6. The communication system of claim 1, wherein enabling the access device to become operational in the communication network comprises provisioning one or more service flows for the access device and all relevant parameters required for the communications in the communication network.

7. The communication system of claim 6, wherein buffers and memory allocations of the access device are configured to support the one or more provisioned service flows.

8. The communication system of claim 1, wherein the configuration file contains a Message Integrity Check (MIC) generated using a shared secret value.

9. The communication system of claim 1, wherein, after previously registering the access device based on the configuration file, the registration/communication server is configured to re-register the access device based on an update to the configuration file without having to reboot the access device.

10. A method for a system comprising a provisioning server, a registration/communication server, and an access device for a communication network, wherein method comprises the registration/communication server communicating with the provisioning server and the access device to register or re-register the access device in the communication network, using a configuration file for the access device, to enable the access device to become operational in the communication network without the access device ever receiving the configuration file.

11. The method of claim 10, wherein:
the registration/communication server is a cable modem termination system (CMTS);
the access device is a cable modem;
the cable modem performs ranging with the CMTS;
in response to the ranging, the CMTS learns the cable modem's address and transmits, to the provisioning server, a Config file request for the configuration file;
in response to the Config file request, the provisioning server transmits the configuration file to the CMTS;
the cable modem transmits a registration request to the CMTS;
in response to the registration request, the CMTS processes information in the configuration file to determine whether to grant the registration request; and
upon the CMTS determining to grant the registration request, the CMTS transmits a registration response to the cable modem to enable the cable modem to become operational in the communication network.

12. The method of claim 10, wherein the registration/communication server communicates with the provisioning server using a secure communication protocol.

13. The method of claim 12, wherein the secure communication protocol is a Hypertext Transfer Protocol Secure (HTTPS) protocol.

14. The method of claim 10, wherein the registration/communication server processes the information in the configuration file along with declared capabilities of the access device to determine whether to grant a registration request from the access device.

15. The method of claim 10, wherein enabling the access device to become operational in the communication network comprises provisioning one or more service flows for the access device and all relevant parameters required for the communications in the communication network.

16. The method of claim 15, wherein buffers and memory allocations of the access device are configured to support the one or more provisioned service flows.

17. The communication system of claim 10, wherein the configuration file contains a Message Integrity Check (MIC) generated using a shared secret value.

18. The method of claim 10, wherein the registration/communication server re-registers the access device based on an update to the configuration file without having to reboot the access device.

19. A registration/communication server for a system further comprising a provisioning server and an access device for a communication network, wherein the registration/communication server comprises a memory and at least one processor, coupled to the memory and operative to cause the registration/communication server to communicate with the provisioning server and the access device to register or re-register the access device in the communication network, using a configuration file for the access device, to enable the access device to become operational in the communication network without the access device ever receiving the configuration file.

20. The registration/communication server of claim 19, wherein:
the registration/communication server is a cable modem termination system (CMTS);
the access device is a cable modem;
the CMTS is configured to receive ranging from the cable modem;
in response to the ranging, the CMTS is configured to learn the cable modem's address and transmit, to the provisioning server, a Config file request for the configuration file;
in response to the Config file request, the CMTS is configured to receive the configuration file from the provisioning server;
the CMTS is configured to receive a registration request from the cable modem;
in response to the registration request, the CMTS is configured to process information in the configuration file to determine whether to grant the registration request; and
upon the CMTS determining to grant the registration request, the CMTS is configured to transmit a registration response to the cable modem to enable the cable modem to become operational in the communication network.

21. The registration/communication server of claim 19, wherein the registration/communication server is configured to communicate with the provisioning server using a secure communication protocol.

22. The registration/communication server of claim 21, wherein the secure communication protocol is a Hypertext Transfer Protocol Secure (HTTPS) protocol.

23. The registration/communication server of claim 19, wherein the registration/communication server is configured to process the information in the configuration file along with declared capabilities of the access device to determine whether to grant a registration request from the access device.

24. The registration/communication server of claim 19, wherein enabling the access device to become operational in the communication network comprises provisioning one or more service flows for the access device and all relevant parameters required for the communications in the communication network.

25. The registration/communication server of claim 24, wherein buffers and memory allocations of the access device are configured to support the one or more provisioned service flows.

26. The registration/communication server of claim 19, wherein the configuration file contains a Message Integrity Check (MIC) generated using a shared secret value.

27. The registration/communication server of claim 19, wherein the registration/communication server is configured to re-register the access device based on an update to the configuration file without having to reboot the access device.

28. A method for a registration/communication server for a system further comprising a provisioning server and an access device for a communication network, wherein the method comprises the registration/communication server communicating with the provisioning server and the access device to register or re-register the access device in the communication network, using a configuration file for the access device, to enable the access device to become operational in the communication network without the access device ever receiving the configuration file.

29. The method of claim 28, wherein:
the registration/communication server is a cable modem termination system (CMTS);
the access device is a cable modem;
the CMTS receives ranging from the cable modem;
in response to the ranging, the CMTS learns the cable modem's address and transmits, to the provisioning server, a Config file request for the configuration file;
in response to the Config file request, the CMTS receives the configuration file from the provisioning server;
the CMTS receives a registration request from the cable modem;
in response to the registration request, the CMTS processes information in the configuration file to determine whether to grant the registration request; and
upon the CMTS determining to grant the registration request, the CMTS transmits a registration response to the cable modem to enable the cable modem to become operational in the communication network.

30. The method of claim 28, wherein the registration/communication server communicates with the provisioning server using a secure communication protocol.

31. The method of claim 30, wherein the secure communication protocol is a Hypertext Transfer Protocol Secure (HTTPS) protocol.

32. The method of claim 28, wherein the registration/communication server processes the information in the configuration file along with declared capabilities of the access device to determine whether to grant a registration request from the access device.

33. The method of claim 28, wherein enabling the access device to become operational in the communication network comprises provisioning one or more service flows for the access device and all relevant parameters required for the communications in the communication network.

34. The method of claim 33, wherein buffers and memory allocations of the access device are configured to support the one or more provisioned service flows.

35. The method of claim 28, wherein the configuration file contains a Message Integrity Check (MIC) generated using a shared secret value.

36. The method of claim 28, wherein the registration/communication server re-registers the access device based on an update to the configuration file without having to reboot the access device.
